(19) United States
(12) Patent Application Publication
(10) Pub. No.: US 2026/0165301 A1
(43) Pub. Date: Jun. 18, 2026

(54) METHOD FOR IDENTIFYING LAMENESS IN CATTLE BASED ON FEATURES OF BACK COMPENSATORY MOVEMENT

(71) Applicant: HENAN UNIVERSITY OF SCIENCE AND TECHNOLOGY, Henan (CN)

(72) Inventors: Kaixuan ZHAO, Henan (CN); Ruihong ZHANG, Henan (CN); Jiangtao JI, Henan (CN); Yue NIAN, Henan (CN); Weizheng SHEN, Heilongjiang (CN); Baisheng DAI, Heilongjiang (CN); Jun WANG, Henan (CN)

(73) Assignee: HENAN UNIVERSITY OF SCIENCE AND TECHNOLOGY, Henan (CN)

(21) Appl. No.: 19/420,623

(22) Filed: Dec. 15, 2025

(30) Foreign Application Priority Data
Dec. 18, 2024 (CN) 202411872738.7

(51) Int. Cl. A01K 29/00; G06T 7/20; G06T 7/73; G06V 10/25; G06V 40/10; G06V 40/20

(52) U.S. Cl. CPC A01K 29/005; G06T 7/20; G06T 7/73; G06V 10/25; G06V 40/10; G06V 40/20; G06T 2207/10028

(57) ABSTRACT

The disclosure discloses a method for identifying lameness in cattle based on features of back compensatory movement, which is to locate key parts of the cattle according to a point cloud image of a back torso, then extract back compensatory features to identify the lameness in the cattle. The back compensatory features include: compensatory movement features including at least one of average speed of a hook and/or a pin bone in vertical direction, average speed of the hook and/or the pin bone in x direction, landing speed of hind hooves, asymmetry of the pin bones, and height difference of a sacral bone at a moment of landing of the hind hooves; and/or compensatory posture features including at least one of maximum height of a contour of a spinal line, a fitting slope of the contour of the spinal line, and a height difference between the pin bone and the hook.

### CROSS-REFERENCE TO RELATED APPLICATION

This application claims the priority benefit of China application serial no. 202411872738.7, filed on Dec. 18, 2024. The entirety of the above-mentioned patent application is hereby incorporated by reference herein and made a part of this specification.

### BACKGROUND

### Technical Field

The disclosure belongs to a field of an intelligent detection technology for cattle, and more particularly, relates to a method for identifying lameness in cattle based on features of back compensatory movement.

### Description of Related Art

Reports indicate that an average lameness rate among cattle is 23.5%, resulting in significant economic losses annually. Timely detection of lame cattle is crucial for both welfare of the cattle and economic benefits of a ranch. The earliest lameness scoring method relies on manual observation. Based on a formulated lameness scoring table, a degree of lameness in the cattle is determined by observing whether the cattle exhibit corresponding lameness behaviors. However, the manual lameness scoring method is inefficient and subjective.

Later, scholars begin to try to quantify indices of manual scoring, initially by simulating a single index of lameness, such as flatness of a back, support time of left and right limbs and hooves, a relative stride length of the left and right limbs and hooves, and a fitting curvature of head and neck contours. Furthermore, it has gradually achieved full coverage of manual scoring for the features. For example, some scholars have extracted six lameness features by tracking positions of limbs and hooves, including gait asymmetry, speed, traceability, asymmetry of standing time, stride length, and ground sensitivity. A box plot of the features shows that the cattle have different indices of lameness at different stages of lameness, verifying feasibility of classifying lameness in the cattle based on the six movement features extracted from swinging of the limbs and hooves.

With development of a computer vision technology, the scholars have begun to capture more detailed and comprehensive features of lameness from both temporal and spatial perspectives than the manual lameness scoring table. Some scholars have used convolutional neural networks to extract micro-movement features from optical flow maps of cattle walking and to classify lameness. Some scholars have conducted in-depth analysis of a movement process of the cattle, proposing features of head-hoof linkage and features of back-hoof linkage, and they have analyzed possibility of using different features for lameness detection, proving that features of head-hoof linkage and the features of back-hoof linkage play an important role in distinguishing cattle with different lameness scores.

The data in the above studies almost all come from a side-view RGB image capturing device. Although the movement of the limbs and hooves of the cattle may be clearly seen from side-view images, the side-view image capturing device usually requires a camera to be 3 to 5 meters away from the cattle, which limits the promotion and application of the side-view image capturing device in cattle farms. Therefore, the scholars come up with an idea of using top-view depth cameras to film videos of cattle walking.

For example, Chinese invention patent application with the publication No. CN113288125A, published on Aug. 24, 2021, discloses a lameness detection method based on a movement trajectory of key points on a body of the cattle. A basic idea of this method is to extract a hoof trajectory and a head movement trajectory from a side-walking video of the cattle, and then extract lameness parameters including inconsistency in strides, inconsistency in stride time, tracking performance, sensitivity of hoof landing, inconsistency in support ratios of hooves, and amplitude of head swing to determine a degree of lameness of the cattle. That is, it assesses the degree of lameness in the cattle based on a side view of the cattle, and a mechanism of back movement stability and compensatory behavior for back lameness are still unclear.

For another example, Chinese invention patent application with the publication No. CN116671899A, published on Sep. 1, 2023, discloses a method and device for early lameness identification in the cattle based on time series anomaly detection. A basic idea of this method is to acquire gait data of the cattle, input the gait data of the cattle into a trained semi-supervised model for abnormal gait identification, and then determine gait symmetry of cattle based on a proportion of abnormal gait, and identify the degree of lameness of the cattle based on the symmetry. This method requires a semi-supervised model for the abnormal gait identification, and the semi-supervised model is required to be trained, which is a complicated process. The abnormal gait identification may only be performed after the training is completed, and it takes a lot of time for training, resulting in low identification efficiency. Moreover, accuracy of the model depends on accuracy of training samples, and it is difficult to achieve high-precision identification with small samples.

### SUMMARY

An objective of the disclosure is to provide a method for identifying lameness in cattle based on features of back compensatory movement, in order to solve an issue of low identification efficiency caused by a method used in the related art.

To solve the aforementioned technical issue, the disclosure provides a method for identifying lameness in cattle based on features of back compensatory movement, including following steps:
1) obtaining a point cloud image of a back torso of the cattle during movement, and locating key parts of the cattle according to the point cloud image of the back torso;
2) extracting back compensatory features according to the key parts, wherein the back compensatory features include compensatory movement features and/or compensatory posture features, the compensatory movement features include at least one of an average movement speed of a hook and/or a pin bone in a vertical direction, an average movement speed of the hook and/or the pin bone in an x direction, a landing speed of hind hooves, asymmetry of the pin bones, and a height difference of a sacral bone (i.e. sacrum) at a moment of landing of the hind hooves, the compensatory posture features include at least one of a maximum height of a contour of a spinal line, a fitting slope of the contour of the spinal line, and a height difference between the pin bone and the hook, and the x direction is parallel to a direction of movement of the cattle;
3) identifying the lameness in the cattle according to the extracted back compensatory features.

Furthermore, the located key parts include the pin bone; a method for calculating the landing speed of the hind hooves is: determine an x-z movement curve of the pin bone according to the located pin bone, and extract a local minimum point in the movement curve of an x-z direction; for one local minimum point, select one point before and one point after the local minimum point, both points are in a vicinity of the local minimum point, calculate an amount of change in values of the pin bone along the z direction in one frame from the selected point after the local minimum point moving to the local minimum point and an amount of change in values of the pin bone along the z direction in one frame from the local minimum point moving to the selected point before the local minimum point, calculate a mean of all the amounts of change in values of the pin bone along the z direction in one frame, and evaluate the landing speed of the hind hooves using the mean; the z direction is the vertical direction.

Furthermore, the located key parts include the pin bone; a method for calculating the asymmetry of the pin bones is: according to the located pin bone, determine movement curves of left and right pin bones in the x-z direction, determine a number of points where the left and right pin bones have different trends of change in the z direction, and evaluate the asymmetry of the pin bones using the number; the z direction is the vertical direction.

Furthermore, the located key parts include the pin bone and the sacral bone; a method for calculating the height difference of the sacral bone at the moment of landing of the hind hooves is: according to the located pin bone and the sacral bone, respectively determine a movement curve of the pin bone in an x-z direction and a movement curve of the sacral bone in the x-z direction, and extract a local minimum point in the movement curve of the pin bone in the x-z direction; obtain a position of the local minimum point in the movement curve of the sacral bone in the x-z direction at a corresponding moment, select one point before and one point after the position, both points are in a vicinity of the position, and calculate a distance between the two selected points in the z direction of the sacral bone, the distance is the height difference of the sacral bone at the moment of landing of the hind hooves; the z direction is the vertical direction.

Furthermore, the located key parts include the spinal line and the hook; a method for calculating a maximum height of the contour of the spinal line is: according to the located hook, determine a movement curve of the hook in an x-y direction, extract a first extreme point in the movement curve of the hook in the x-y direction, and determine the spinal line at a moment corresponding to the first extreme point; calculate a maximum value of the spinal line in the z direction, and the maximum value is the maximum height of the contour of the spinal line; a y direction is along a horizontal direction and perpendicular to the x direction, and the z direction is the vertical direction.

Furthermore, the located key parts include the spinal line and the hook; a method for calculating a fitting slope of the contour of the spinal line is: according to the located hook, determine the movement curve of the hook in the x-y direction, extract the first extreme point in the movement curve of the hook in the x-y direction, and determine the spinal line at the moment corresponding to the first extreme point; calculate the fitting slope of the spinal line, and the fitting slope is the fitting slope of the contour of the spinal line; the y direction is along the horizontal direction and perpendicular to the x direction, and the z direction is the vertical direction.

Furthermore, the located key parts include the pin bone and the hook; a method for calculating the height difference between the pin bone and the hook is: according to the located hook and the pin bone, respectively calculate an average value of the hooks in the z direction and an average value of the pin bones in the z direction, and calculate a difference between the two average values, and the difference is the height difference between the pin bone and the hook; the z direction is the vertical direction.

Furthermore, a method for locating the spinal line is:
2.1) use a sliding window with an equal side length and step size to traverse a frame of the point cloud image of the back torso and calculate a sum of depth values of each of windows; search the window with the largest sum of the depth values in each of columns, and determine a coordinate of a certain position of the window as one of initial coordinates for locating the spinal line, wherein the column is located in a y direction, and the y direction is along a horizontal direction and perpendicular to the x direction;
2.2) fit all the initial coordinates for locating the spinal line determined in the step 2.1) to obtain a fitting line, expand a first set region in both the positive and negative y directions with the fitting line as a starting position, and identify the expanded region as a region where the spinal line may exist;
2.3) use the sliding window to traverse the region where the spinal line may exist, and calculate the sum of the depth values of each of the windows; search the window with the largest sum of the depth values in each of the columns, and determine a coordinate of a certain position of the window as one of final coordinates for locating the spinal line; determine the spinal line in the frame of the point cloud image of the back torso according to all the final coordinates for locating the spinal line.

Furthermore, a method for locating the hook is:
3.1) locate the spinal line in a frame of the point cloud image of the back torso, and rotate the image using the spinal line, so that an angle of the spinal line is 0;
3.2) traverse the rotated image column by column along the x direction to find a maximum depth value of each of columns; for a column, compare a depth value of each of pixels in the column with the maximum depth value of the column, and delete pixels that have a difference from the maximum depth value greater than a set difference threshold; then search a largest connected component in the image to be used as a top torso region, wherein the column is located in a y direction, and the y direction is along a horizontal direction and perpendicular to the x direction;
3.3) traverse along the x direction, calculate a pixel sum of each of the columns in a binary image of the top torso region, find a column with a maximum pixel sum, and identify the column as a column where the hook may exist;
3.4) define a rectangular region, wherein upper and lower boundaries of the region are upper and lower boundaries of a torso, and left and right boundaries of the region are the boundaries obtained by extending a second set region in both the positive and negative x directions with the column where the hook may exist as a starting position, and the rectangular region is a region where the hook may exist;
3.5) use a sliding window with an equal side length and step size to traverse a y-z scatter plot in the region where the hook may exist, replace all points in each of windows with a single point, and replace with a mean of y and z coordinates of all the points in the window, thereby using all the replacement points to obtain a fitting curve;
3.6) extract a convex hull of the fitting curve, calculate an area between a straight line where any two adjacent points are located on the convex hull and corresponding points on the fitting curve, find two points with the largest area that are located on the fitting curve and near two local maximum points of the fitting curve respectively, wherein the two points are the located left and right hook points.

Furthermore, a method for locating the pin bone is:
4.1) locate an oxtail bone region in the point cloud image of the back torso;
4.2) in an xoy plane, with a column where the oxtail bone region is located as a column where left and right pin bone regions are located, a row between an uppermost side of a torso and a largest row of the oxtail bone region is used as a row where the right pin bone region is located, a row between a smallest row of the oxtail bone region and a lowermost side of the torso is used as a row where the left pin bone region is located, wherein the column is located in a y direction, and the y direction is along a horizontal direction and perpendicular to the x direction;
4.3) retain the columns with larger x values in the left pin bone region, and use an average value of points of the retained columns as a coordinate value of a coarse location point of left hook; retain the columns with larger x values in the right pin bone region, and use an average value of points of the retained columns as a coordinate value of a coarse location point of right hook;
4.4) define two rectangular regions in the xoy plane, wherein upper and lower boundaries of one of the rectangular regions are lines after a connecting line of the left hook point and the coarse location point of left pin bone is translated upward and downward by set pixel points respectively, left and right boundaries of the rectangular region are perpendicular to the connecting line of the left hook point and the coarse location point of left pin bone, and one of the left and right boundaries has points after the coarse location point of left pin bone is translated towards a direction of a tail of the cattle by several pixel points, and the other of the left and right boundaries has points after the coarse location point of left hook is translated towards a direction of a head of the cattle by several pixel points; upper and lower boundaries of the other of the rectangular regions are lines after a connecting line of the right hook point and the coarse location point of right pin bone is translated upward and downward by set pixel points respectively, left and right boundaries of the rectangular region are perpendicular to the connecting line of the right hook point and the coarse location point of right pin bone, and one of the boundaries has points after the coarse location point of right pin bone is translated towards the direction of the tail of the cattle by several pixels, and the other of the boundaries has points after the coarse location point of right hook is translated towards the direction of the head of the cattle by several pixels;
4.5) process the two obtained rectangular regions as follows: traversing an x-z scatter plot of the rectangular region using a sliding window with an equal side length and step size, replacing all points in each of windows with a single point, and replacing with a mean of x and z coordinates of all the points in the window, thereby using all the replacement points to obtain a fitting curve; extract a convex hull of the fitting curve, calculating an area between a straight line where any two adjacent points are located on the convex hull and the fitting curve, finding points with the largest area on the fitting curve, and using a point closest to a tail of the cattle as one of the pin bone points, wherein a z direction is a vertical direction.

Furthermore, a method for locating the sacral bone is: locate the spinal line and the left and right hooks in a frame of the point cloud image of the back torso, wherein if a column where the left and right hooks are located intersects with the spinal line, then the intersection point is a position of the sacral bone; if the column where the left and right hooks are located does not intersect with the spinal line, then a point that is closer to both the column where the left and right hooks are located and the spinal line is considered to be the position of the sacral bone; the column is located in a y direction, and the y direction is along a horizontal direction and perpendicular to the x direction.

Furthermore, the method for identifying the lameness in the cattle based on the extracted back compensatory features is:
compare each of the back compensatory features with a corresponding back compensatory feature threshold, and determine a corresponding feature score according to a magnitude relationship between each of the back compensatory features and the corresponding back compensatory feature threshold; obtain a total score of the compensatory movement features by adding feature scores corresponding to each of compensatory movement features, and obtain a total score of the compensatory posture features by adding feature scores corresponding to each of the compensatory posture features; evaluate a degree of lameness in the cattle according to the total score of compensatory movement features and the total score of compensatory posture features.

Furthermore, a method for determining the back compensatory feature threshold corresponding to the compensatory movement features is: obtain box plots of compensatory movement features of healthy and mildly lame cattle, calculate an average value of a lower quartile of the box plot of the healthy cattle and an upper quartile of the box plot of the mildly lame cattle, and use the average value as the back compensatory feature threshold corresponding to the compensatory movement features;
and/or
a method for determining the back compensatory feature threshold corresponding to the compensatory posture features is: obtain box plots of compensatory posture features of mildly lame and severely lame cattle, calculate an average value of a lower quartile of the mildly lame cattle and an upper quartile of the severely lame cattle, and use the average value as the back compensatory feature threshold corresponding to the compensatory posture features.

Furthermore, a method for obtaining the point cloud image of the back torso of the cattle during the movement is: obtain point cloud data by capturing a back of the cattle during the movement, subtract it from a captured depth image of a background, and retain an image region having a difference that meets requirements; search the largest connected component in the retained image region and fill holes in the image region; then remove head and neck regions in the image to obtain the point cloud image of the back torso of the cattle during the movement.

The disclosure is a pioneering invention, and beneficial effects thereof are as follows: in the disclosure, an in-depth analysis of a stability mechanism of back movement of the cattle is conducted, and features that may reflect compensatory behaviors of the back of the cattle are extracted. The features specifically include compensatory movement features and/or compensatory posture features. The compensatory movement features include at least one of the average movement speed of the hook and/or pin bone in the vertical direction, the average movement speed of the hook and/or pin bone in the x direction, the landing speed of hind hooves, the asymmetry of the pin bones, and the height difference of the sacral bone at the moment of landing of the hind hooves. The compensatory posture features include at least one of the maximum height of the contour of the spinal line, the fitting slope of the contour of the spinal line, and the height difference between the pin bone and the hook. The features are obtained by locating the key parts in the point cloud image of the back torso of the cattle and then calculating the location results of the key parts. The whole process does not require training, which greatly improves the identification efficiency. The extracted features may be used directly to quickly identify the lameness of the cattle.

### BRIEF DESCRIPTION OF THE DRAWINGS

FIG. 1 is a schematic diagram of an image capturing device according to the disclosure.

FIG. 2 is a three-dimensional point cloud diagram of a back torso region of cattle according to the disclosure.

FIG. 3 is a diagram showing a location result of a spinal line according to the disclosure.

FIG. 4 is a binary image of a top torso region (Tb) according to the disclosure.

FIG. 5 is a diagram showing a location result of a region hookR according to the disclosure.

FIG. 6 is a diagram showing a fitting result of a convex hull line and a location result of hook points according to the disclosure.

FIG. 7 is a diagram showing a location result of an oxtail bone according to the disclosure.

FIG. 8 is a diagram of a region Thr according to the disclosure.

FIG. 9 is a diagram showing a fitting result of a convex hull line and a location result of pin bone points according to the disclosure.

FIGS. 10A and 10C are respectively diagrams showing movement trajectories of hooks x-z and x-y according to the disclosure.

FIGS. 10B and 10D are respectively diagrams showing movement trajectories of pin bones x-z and x-y according to the disclosure.

FIG. 11 is a curve graph of a height of a spine according to the disclosure.

FIG. 12 is a schematic diagram of a method for calculating Zh1, Zh2, Zh3, and Zh4 according to the disclosure.

FIG. 13 is a schematic diagram of a method for calculating Psz according to the disclosure.

FIG. 14 is a box plot of Pvx according to the disclosure.

FIG. 15 is a flowchart of a method for identifying lameness in cattle based on features of back compensatory movement according to the disclosure.

### DETAILED DESCRIPTION OF DISCLOSED EMBODIMENTS

A core concept of the disclosure is to locate key parts of cattle according to a point cloud image of a back torso, extract back compensatory features according to the key parts, and identify lameness in the cattle based on the extracted back compensatory features. The back compensatory features are features extracted through an in-depth analysis of a stability mechanism of back movement of the cattle, specifically including compensatory movement features and/or compensatory posture features. The compensatory movement features include at least one of an average movement speed of the hook and/or pin bone in a vertical direction, an average movement speed of the hook and/or pin bone in an x direction, a landing speed of hind hooves, asymmetry of the pin bones, and a height difference of a sacral bone at a moment of landing of the hind hooves. The compensatory posture features include at least one of a maximum height of a contour of a spinal line, a fitting slope of the contour of the spinal line, and a height difference between the pin bone and the hook. The x direction is parallel to a direction of movement of the cattle. Thus, identification efficiency is greatly achieved without the need for training.

In order for the objectives, technical solutions, and advantages of the disclosure to be clearer, the disclosure will be further described in detail below with reference to the accompanying drawings and embodiments.

The disclosure provides a method for identifying lameness in the cattle based on features of back compensatory movement. First, top-view depth walking images of the cattle are collected on a path where the cattle return to a barn to construct a dataset. Then, according to features of a skeletal structure and movement mechanism of the cattle, the key parts of the cattle are located: the hook, pin bone, sacral bone, and spinal line, and based on the location results, movement curves of the key parts are drawn. Then, according to the drawn movement curves and height curves of the spine, the back compensatory movement features and the back compensatory posture features are extracted. On this basis, a lameness classification model is constructed using a threshold discrimination method. A specific process is shown in FIG. 15, and the content is as follows:

In step 1, data is collected.

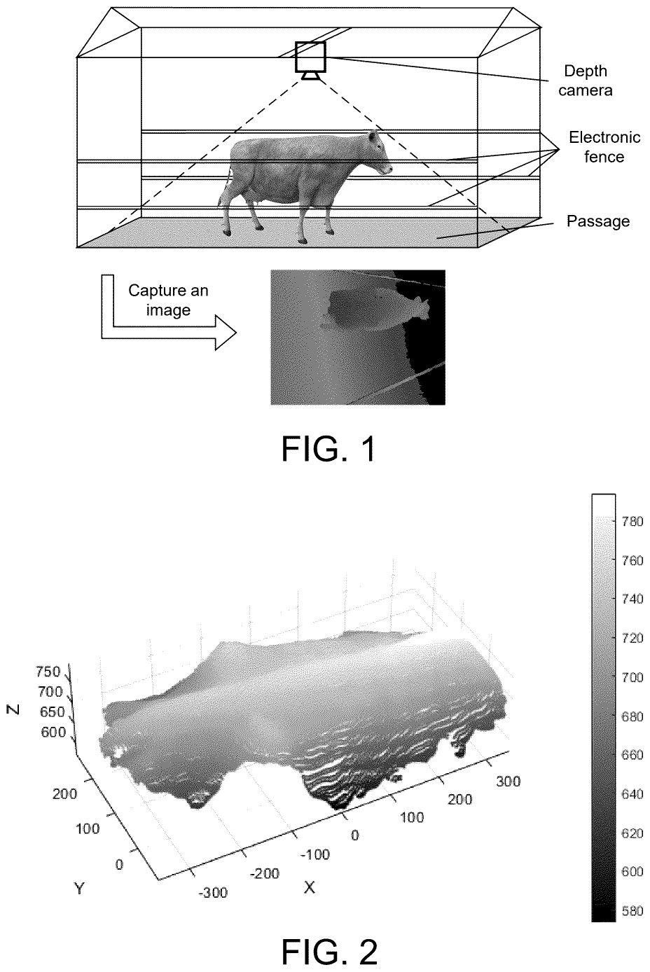

After milking, Holstein cows in lactation return to the barn through a designated passage, and this process is captured. A depth camera (Intel RealSense D455) is mounted directly above a center of the passage, 2.7 m above the ground, and tilted 33° toward a direction the cattle are walking in order to capture the complete walking process of the cattle. A data collection device is shown in FIG. 1. Before the cattle walking is captured, a depth image of a background (excluding the cattle) is taken for later background removal. The depth camera starts capturing when the cattle enter a top-view field of view of the camera and stops capturing when the cattle completely leave the top-view field of view of the camera. A capturing process may be controlled manually.

In step 2, the dataset is constructed. Specifically,
1) Videos are filtered. The videos are filtered, and videos showing cattle gathering or remaining still are removed.
2) Limpness is scored manually. Three experienced observers manually score the videos of the cattle walking to classify the cattle into healthy (S category), mildly lame (ML category), and severely lame (SL category).
3) A point cloud coordinate system is converted. First, using intrinsic parameter data obtained by calibrating the depth camera, a pixel coordinate system in the depth image is converted into a world coordinate system. Then, plane fitting is performed according to a captured ground portion to obtain a ground expression. Then, the real ground is used as a new XOY plane to rotate the point cloud.
4) The background is removed. First, the depth image of the captured background is subtracted from the obtained point cloud data, and an image region with a difference of less than −500 (in pixels) are retained. Next, the largest connected component in the image is searched. Finally, holes in the image are filled to obtain clean point cloud data of the back of the cattle.
5) The head and the neck are removed. Since the head and the neck are relatively narrow, statistical methods are used to search the narrowest column of the torso region and remove the right side region of the column, leaving the back torso region of the cattle. A point cloud image of the back torso region and the constructed xyz coordinate system are shown in FIG. 2. The z coordinate is a depth coordinate.

In step 3, the key parts of the back of the cattle are located.

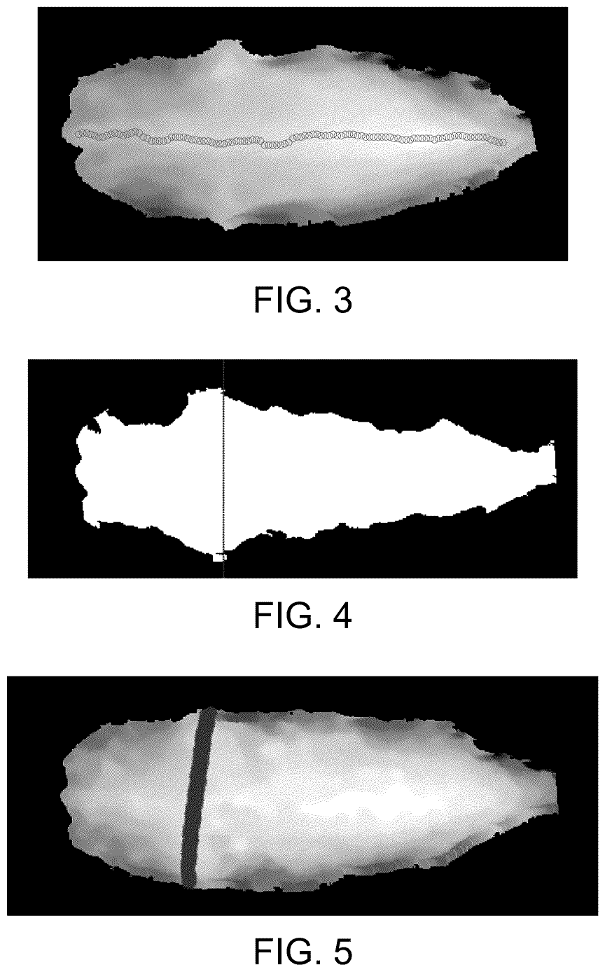

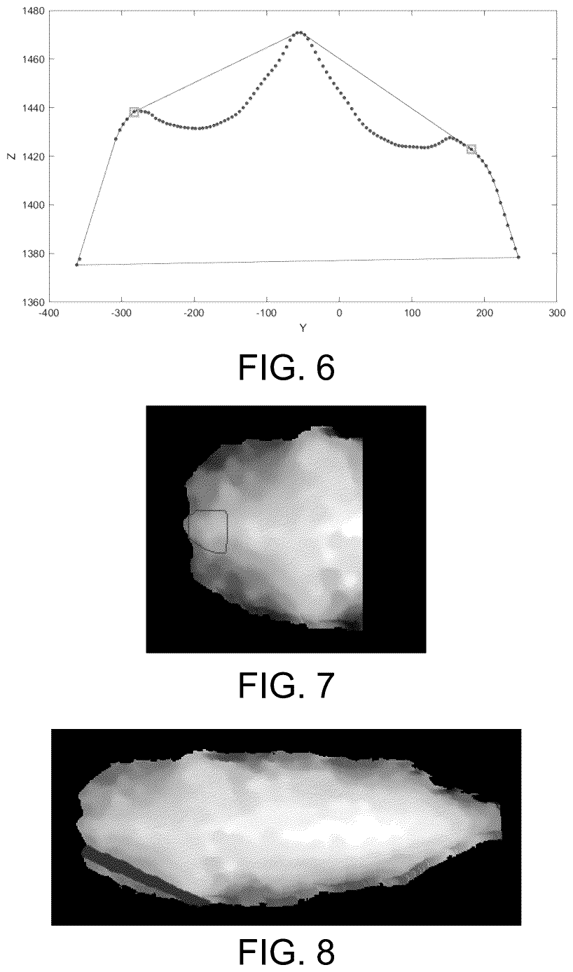

According to the skeletal structure and the movement mechanism of the cattle, in this embodiment, the hook, pin bone, spinal line, and sacral bone are selected as the key parts of the back of the cattle, and these key parts are located.
1. The spinal line of the cattle is located. According to a physiological structure of the cattle, the spinal line is located near a line of symmetry of the back torso of the cattle, and a region where the spinal line is located is higher than a surrounding back surface. On this basis, a locating process of the spinal line is designed as follows:
(1) The spinal line is first located. Using a sliding window with a side length of 5 pixels and a step size of 5 pixels, traversing the entire cattle region in the xoy plane, and a sum of depth values of each of windows is calculated. The window with the largest sum of the depth values in each of columns is searched, and the coordinates (x, y) of the top left corner of this window is considered to be one of the coordinates of the spinal line of the cattle. The columns here are in the same direction as the y axis.
(2) Fitting is performed on the spinal line. After the first traversal search, the (x, y) coordinates of the spinal line of the cattle are fitted using a least squares method, and points that differ significantly from the fitted values are removed. 30 rows are expanded along the fitting straight line of the spine in both positive and negative y-axis directions (a region obtained by expanding 30 rows is a first set region, which may be adjusted according to an actual situation). This region is considered to be a region Br where the spinal line may exist.
(3) The spinal line is finally located. Using the sliding window with the side length of 5 pixels and the step size of 5 pixels, the region Br where the spinal line may exist is traversed along the xoy plane. The coordinate values of the spinal line are searched again using the same location method as used in the first location. FIG. 3 shows a location result of the spinal line, and circles represent the location results of the spinal line.
2. The hook of the cattle is located. The hook of the cattle is a pair of skeletal structures with protrusion features symmetrically distributed on two sides of the spinal line. According to physiological characteristics thereof, a method for locating the hook used in the disclosure is as follows:
(1) The image is corrected. According to a tilt angle of the fitting line of the spine, the image is rotated, so that the angle of the fitting line of the spine of the cattle is 0.
(2) A top torso region is located. The cattle region is traversed column by column along an x-axis direction, a maximum z value Zjmax (i.e., a maximum depth value) of each of the columns is found, and the z value of each of pixel points in the column is compared with Zjmax. The pixel point that has a difference from Zjmax greater than 100 (i.e., a set difference threshold, which is in pixels) is deleted. Next, the largest connected component in the image is searched as a top torso region Tb. FIG. 4 shows a binary image of the region Tb.
(3) The column where the hook may exist is searched. Traversing along an x-axis direction, a sum pixel of each of the columns in the binary image of the region Tb is calculated, the column with a maximum pixel sum is found, and it is considered to be a column hookj where the hook may be located. A vertical line mark as shown in FIG. 4 is the column hookj where the hook may be located.
(4) The hook point is located.
\textcircled{1} A rectangular region is defined with the column hookj as a center. Left and right boundaries of the rectangular region are boundaries obtained by expanding the column hookj along the negative and positive x-axis directions by 10 columns respectively (a region expanded by 10 columns is a second set region, and the region may be adjusted according to the actual situation). Upper and lower boundaries are upper and lower boundaries of the torso. As a region hookR where the hook may exist, a black region in the three-dimensional point cloud diagram shown in FIG. 5 is the region hookR.
\textcircled{2} An x coordinate of the region hookR is ignored. In order to simplify y and z values in this region into a curve, a sliding window with a size of 5*5 and the step size of 5 (pixels) is used to traverse a y-z scatter plot and replace all points in each of the windows with one single point. A y coordinate of the replacement point is a mean of the y coordinates of all the points within the sliding window, and a z coordinate of the replacement point is a mean of the z coordinates of all the points within the sliding window, thereby obtaining a y-z fitting curve for the column hookj.
\textcircled{3} A minimum convex polygon of the fitting curve is constructed, i.e., a convex hull. An area between a straight line fitted by the i-th point and the i+1-th point of the convex hull and corresponding points of the y-z fitting curve is calculated. The two points with the largest area on the y-z fitting curve are found, which are located near the two local maximum points of the y-z curve, and are located at two ends of the curve. These two points are taken as left and right hook points Hl and Hr of the torso of the cattle. FIG. 6 shows a fitting result of a convex hull line. Black dots in the figure represent the y-z fitting curve of the column hookj, a black solid line represents the fitting line of the convex hull, and gray-marked points are location results of the left and right hook points.
3. The pin bone of the cattle is located. The pin bone of the cattle is a pair of skeletal structures with protrusion features symmetrically distributed on two sides of an oxtail bone. According to physiological characteristics thereof, a method for locating the hook used in the disclosure is as follows:
(1) The oxtail bone is located. First, the image is cropped, and images with y value greater than (hookj+40) (40 refers to the pixels) are cropped, so as to obtain a hindquarter image of the cattle. According to a depth value of the hindquarter image, the depth image is converted into a color image. A yolov8 model (or other target localization models in the related art) is trained to locate a position of the oxtail bone in the hindquarter image. FIG. 7 shows a location result of the oxtail bone. An area within a black outline in the figure is the location result of the oxtail bone.
(2) Left and right pin bone regions are located. The left and right pin bone regions within the xoy plane are defined. The column where the oxtail bone region is located is used as the column where the left and right pin bone regions are located. A right pin bone region pinR1 is defined to be from an uppermost side of the torso to the largest row of the oxtail bone, and a left pin bone region pinL2 is defined to be from the smallest row of the oxtail bone to a lowermost side of the torso.
(3) The pin bone point is coarsely located. The 10 columns with the larger values along the x-axis direction in the left pin bone region (a direction with the larger x value is a direction towards the head of the cattle) are retained, and an average value of the points in this pin bone region is used as a coordinate value of a coarse location point of left pin bone Pl1; the 10 columns with the larger values along the x-axis direction in the right pin bone region are retained, and an average value of the points in this pin bone region is used as a coordinate value of a coarse location point of right pin bone Pr1. The left pin bone is located to the left of the right pin bone, so the y value thereof is required to be less than that of the right pin bone. Therefore, the y values of the left and right pin bones are compared. If the y value of the left pin bone is greater than that of the right pin bone, then the x, y, and z values of the left and right pin bones are swapped.
(4) The pin bone point is precisely located.
\textcircled{1} Precise location methods of the left and right pin bone points are similar, so only the method for locating the left pin bone point is introduced here. A region Thr is defined in the xoy plane. Upper and lower boundaries of this region are connecting lines of the left hook point Hl and the coarse location point of left pin bone Pl1, translated upward and downward by 10 pixel points respectively. The left boundary is a straight line that is translated by 100 pixel points in the negative x-axis direction (a direction actually towards the tail of the cattle) from the coarse location point of left pin bone Pl1, and is perpendicular to the connecting line of the left hook point Hl and the coarse location point of left pin bone Pl1. The right boundary is a straight line that is translated by 100 pixel points in the positive x-axis direction (a direction actually towards the head of the cattle) from the left hook point Hl, and is perpendicular to the connecting line of the left hook point Hl and the coarse location point of left pin bone Pl1. The defined region Thr is shown as a black area in FIG. 8.
\textcircled{2} The y coordinate of this region is ignored. The x and z values within this region are simplified. The points in an x-z plane are processed using the sliding window with the size of 5*5 and the step size of 5 (in pixels), and all the points within each of the windows are replaced with one single point. An x coordinate of the replacement point is a mean of the x coordinates of all the points within the sliding window, and the z coordinate of the replacement point is the mean of the z coordinates of all the points within the sliding window. As a result, an x-z fitting curve is obtained.
\textcircled{3} A minimum convex polygon of the x-z fitting curve is constructed, i.e., the convex hull. An area between the straight line fitted by the i-th fitting point and the i+1-th fitting point of the convex hull and the x-z fitting curve is calculated to find the point with the largest area, and this point is located on the x-z fitting curve and close to a position of an extreme point of the x-z fitting curve. The extreme point with the smallest x value is used as the left pin bone point. FIG. 9 shows a fitting result of the convex hull line. A dashed line represents the x-z curve, and a black solid line represents the fitting line of the convex hull. A gray-marked point in the figure represents the location result of the left and right pin bone points.

The method for locating the right pin bone point is similar to that for locating the left pin bone point, and will not be repeated below.
4. The sacral bone is located. The sacral bone is located in a middle position between the left and right hooks. If the column where the left and right hooks are located intersects with the spinal line, then that intersection point is a position of the sacral bone. If the column where the left and right hooks are located does not intersect with the spinal line, then a point that is closer to both the column where the left and right hooks are located and the spinal line is considered to be the position of the sacral bone.

In step 4, the movement curves of the key parts are drawn.
1. Three-dimensional movement curves of the left and right hooks and the pin bone are drawn.

According to the location results of the left and right hooks and the pin bone, an x-y movement curve and an x-z movement curve of the left and right hooks are drawn respectively, and pre-processing are performed on the curves.

First, outliers in the curves are detected and replaced. The outliers are detected using a window with a length of 5. The outliers are defined as elements that, within a specified window length, differ from a local median by more than three times a product of a local conversion coefficient and median absolute deviation (MAD). This method is also known as the Hampel filter. A filling method for replacing the outliers is to perform linear interpolation based on adjacent non-outliers. Next, smoothing processing is performed on the curves. The smoothing processing is performed using local regression with weighted linear least squares and a quadratic polynomial model. A number of data points used to calculate smoothed values is 7.

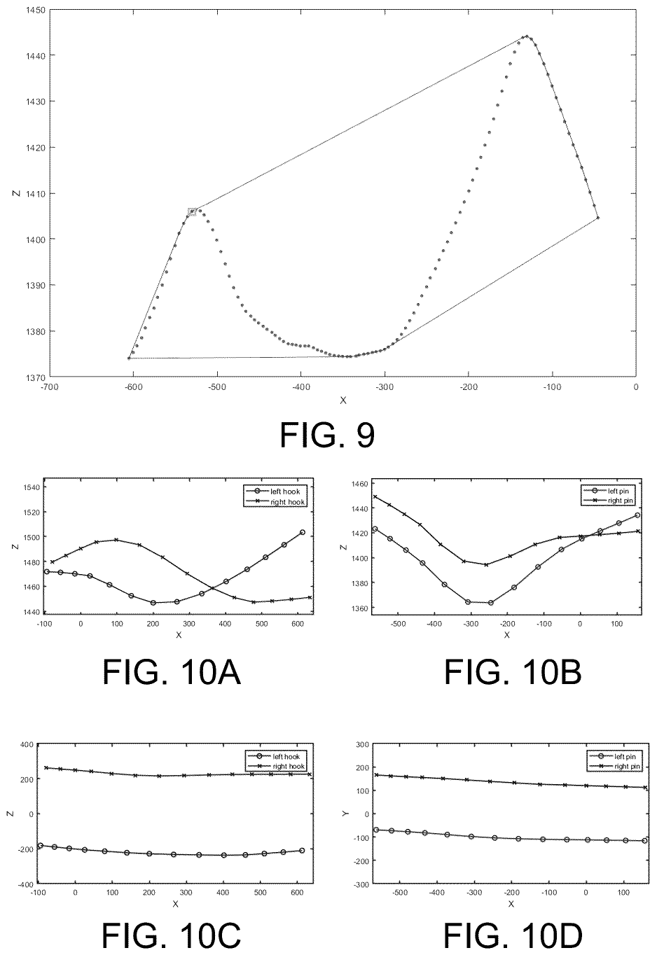

The movement curves of the left and right hooks and the pin bone after processing are shown in FIGS. 10A to 10D.
2. The height curve of the spine is drawn.

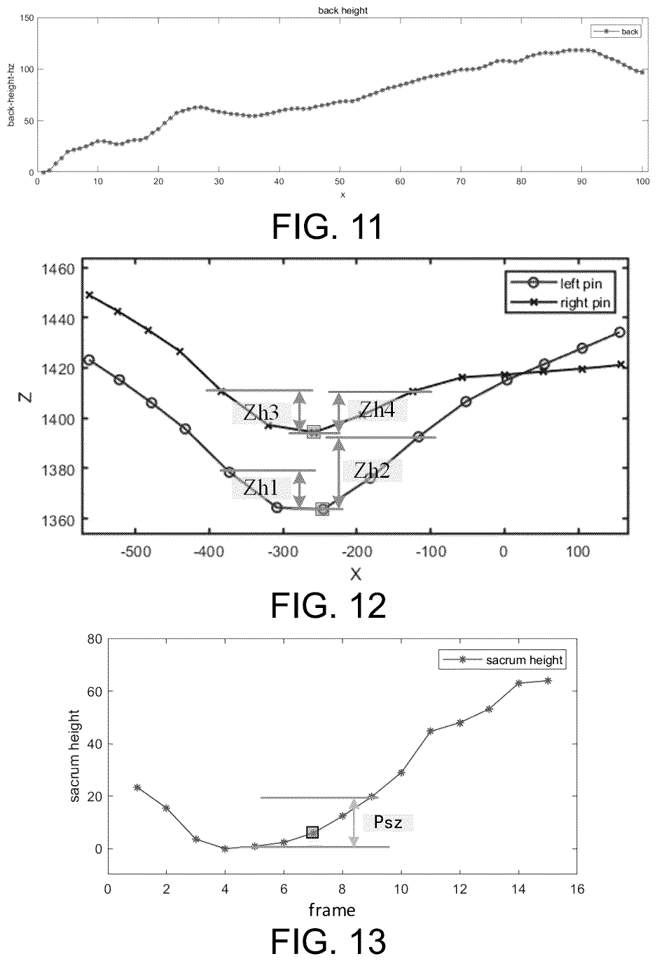

A height of the spinal line corresponding to the first extreme point of the x-y curve of the hook of the cattle is obtained, and a height line of the spine of the cattle is drawn. Since a value of a spinal curve is relatively large, it is not conducive to subsequent data processing. Therefore, a relative height of the spinal curve is calculated. A minimum value of the first half of the spinal contour curve is searched, and the minimum value is subtracted from the contour curve to obtain the relative height of the spinal curve, as shown in FIG. 11. The replacement of the outliers and smoothing processing of the curves are performed on the spinal contour line.

In step 5, the back compensatory features are extracted.
1. The compensatory movement features specifically include the following features:
(1) An average velocity of movement Pvx of the left and right hooks and the pin bone along the x axis. A calculation method thereof is to respectively calculate velocities of movement of the left and right hooks and the pin bone of the cattle along the x axis, and calculate an average value. This feature reflects whether the cattle have the ability to move freely.
(2) An average velocity of movement Pvz of the left and right hooks and the pin bone along a z axis. A calculation method thereof is to respectively calculate velocities of movement of the left and right hooks and the pin bone of the cattle along the z axis, and calculate an average value. This feature reflects whether limbs and hooves of the cattle are fully lifted and extended.
(3) A landing speed Ppz of the hind hooves. A calculation method thereof is to search all local minimum points in the x-z curve of the pin bone, and respectively calculate an average value of changes in the z values within a range of two points on left and right sides of the local minimum point in the x-z curve of the left and right pin bones, as shown in the formula (1). Although this value is a distance value, it may reflect the landing speed of the hind hooves and is an amount of change in values along the z direction in one frame. According to an analysis of the side-view and top-view videos of the cattle walking, it is found that a vicinity of the local minimum point of the pin bone usually corresponds to a landing point of the hind hooves during movement of the cattle. Therefore, this feature value represents the landing speed of the hind hooves at a moment of landing, reflecting whether the hind hooves have normal support capacity.

$$Pzm = ( Zh 1 + Zh 2 + Zh 3 + Zh 4 ) / 8 \qquad ( 1 )$$

A calculation method of Zh1, Zh2, Zh3, and Zh4 are shown in FIG. 12.

It should be noted that the formula (1) is for a calculation method of a single minimum value. If there are multiple minimum values, the calculation may be performed on all the minimum values in accordance with the formula (1), and then an average value of calculation results of all the minimum values corresponding to the formula (1) may be taken as a final result.
(4) The asymmetry Plr of the pin bones. A calculation method thereof is to search a number of points where the z values of the left and right pin bones have different upward and downward trends. This number may reflect the asymmetry of the left and right pin bones. According to the analysis of the side-view and top-view videos of the cattle walking, the pin bone of the cattle is a structure that maintains body balance, and a function thereof is more similar to a fixed fulcrum of the hook. Therefore, when the cattle walk normally, the left and right pin bones should rise or fall simultaneously along the z axis. When the cattle put one diseased hoof on the ground, the cattle will make compensatory movements to relieve the pain, and the left and right pin bones thereof will show different trends of change. This feature reflects symmetry of the movement of the cattle.
(5) A height difference Psz of the sacral bone at the moment of landing of the hind hooves. A calculation method thereof is to obtain a Z-value change curve of the sacral bone in a frame corresponding to the landing point of the hind hooves (i.e. the minimum point in the x-z curve of the pin bone) and two frames before and two frames after the landing point of the hind hooves, and calculate a difference between the maximum and minimum values, as shown in FIG. 13. A point marked with a box in FIG. 13 is the landing point. The sacral bone of the cattle is located almost in a center position of a hindquarter, and changes in a height thereof basically reflect changes in a height of the entire hindquarter. When the cattle walk normally, strides and lift heights of the hind hooves are relatively large, resulting in a large vertical swing amplitude of the hindquarter and the sacral bone at the moment of landing of the hind hooves; when the cattle suffer from lameness, resulting in stiff limbs and hooves, the strides and lift heights of the hind hooves are smaller, and thus the vertical swing amplitude of the hindquarter and sacral bone is also smaller at the moment of landing of the hind hooves. This feature indirectly reflects followability of movement of the cattle.
2. The compensatory posture features.
(1) A maximum height Pbm of the contour of the spinal line at a suspended point. A calculation method thereof is to obtain the spinal line corresponding to the first extreme point of the x-y curve of the hook of the cattle, and calculate a maximum value Pbm of the height of the spinal line in this frame. Since the height of the spine of the cattle changes as it walk, it is necessary to extract the features of the spinal line corresponding to a certain state of the cattle. According to the analysis of the side-view and top-view videos of the cattle walking, the extreme points of the x-y curve of the left and right hooks of the cattle usually correspond to a moment when the limbs and hooves reaching below the torso as the cattle move. This feature value reflects whether the cattle have arched backs.
(2) A fitting slope Pbx of the contour of the spinal line at the suspended point. A calculation method thereto is to, same to the calculation method of the maximum height Pbm of the contour of the spinal line, obtain the spinal line corresponding to the first extreme point of the x-y curve of the hook of the cattle, and calculate the fitting slope Pbx of the spinal line in that frame using the least squares method. This feature reflects whether a center of gravity of the cattle has shifted forward or backward. It should be noted that the “suspended point” in the names the maximum height Pbm and the fitting slope Pbx refers to the hind hooves of the cattle being suspended in the air.
(3) A height difference Pd between the pin bone and the hook. A calculation method thereof is to calculate a difference between an average value of z-value change ranges of the left and right pin bones and an average value of z-value change range of the left and right hooks. According to the skeletal structure of the cattle, the pin bone of the normal cattle is slightly lower than the hook. When the cattle are severely lame, to reduce the load, upper joints of the hind hooves flex to lower the center of gravity of the hind half of the torso. Therefore, when the cattle with severe lameness walk, the height of the pin bone thereof will be significantly lower than the height of the hook thereof. Therefore, this feature reflects the support capacity of the hind hooves.

In step 6, the lameness is classified.

An idea behind a threshold segmentation method is to provide a lameness score for the lame cattle using a set threshold and superposition of compensatory movement behaviors. First, a suitable threshold is found for each of features based on a box plot of the features, and it is determined whether the cattle exhibit the lameness behavior corresponding to this feature according to the threshold. Then, a degree of lameness of the cattle is determined based on the superposition of different lameness behaviors.
(1) Identification of the lameness behavior.

After an analysis of the box plots for eight features, it is found that the S-type cattle are significantly distinguished from the ML-type cattle and SL-type cattle in the compensatory movement features. The S-type cattle exhibit larger movement amplitudes, while the ML-type and SL-type cattle exhibit smaller movement amplitudes. The S-type cattle and ML-type cattle are significantly distinguished from the SL-type cattle in the compensatory posture features, and the SL-type cattle exhibit a higher degree of pose abnormality than the S-type and ML-type type cattle. Therefore, the designed classification method is as follows:

First, a threshold is set for each of the features to determine whether the cattle exhibit the corresponding compensatory behavior. For each of the compensatory movement features, the discrimination threshold is determined by the box plots of the S type and ML type. Specifically, it is calculated as an average value of a lower quartile of the S-type feature box and an upper quartile of the ML-type feature box. For each of the compensatory posture features, the discrimination threshold is determined by the box plots of the ML type and SL type. Specifically, it is calculated as an average value of the lower quartile of the ML-type feature box and the upper quartile of the SL-type feature box. Next, according to the threshold corresponding to each of the features and the distribution of different scoring feature boxes, it is determined whether the cattle exhibit the corresponding compensatory features, and the feature is assigned two-dimensional features of “0” (normal) and “1” (lame).

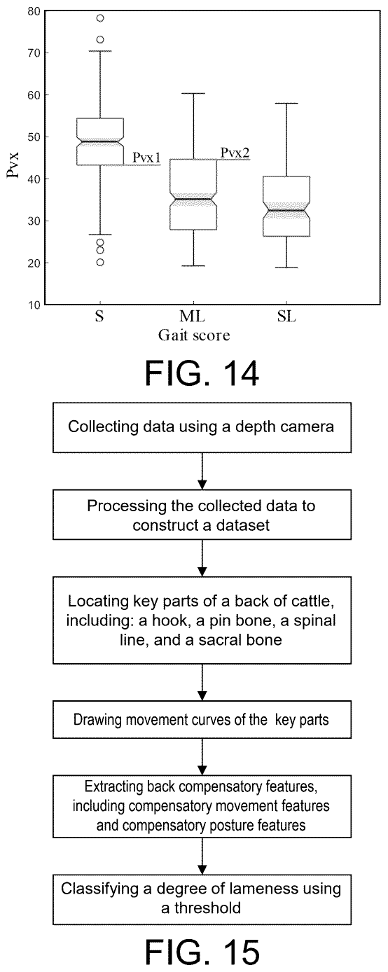

Taking the compensatory movement feature Pvx as an example, first, Pvx1 and Pvx2 are obtained according to a box plot thereof (FIG. 14), and a threshold Tvx is calculated according to the following formula (2):

$${T}_{Vx} = ( Pvx 1 + Pvx 2 ) / 2 \qquad ( 2 )$$

Next, according to the feature boxes of three scorings, it can be seen that the walking speed of the ML-type and SL-type cattle is generally lower than that of the S-type cattle. Therefore, when an average walking speed Pvxi of the cattle along the x axis is greater than the threshold Tvx, it is considered that the cattle do not exhibit this lameness behavior, and the value of the two-dimensional feature of Pvx is “0”. When an average walking speed Vx of the cattle along the x axis is less than the threshold Tvx, the cattle are suspected of having lameness symptoms, and a value of a two-dimensional feature Bvx of the walking speed is “1”. A specific calculation method is shown in the following formula (3). The values of the two-dimensional features may also be called feature scores.

$$Bvx = \{ \begin{matrix}0 , Pvxi \geq {T}_{Vx} \\ 1 , Pvxi < {T}_{Vx}\end{matrix} \qquad ( 3 )$$

In the formula, Pvxi represents the average speed of the cattle along the x axis.

Using the above method, thresholds Tvz, Tpz, Tlr, Tlz, Tbm, Tbx, and Td for the other 7 features and two-dimensional features Bvz, Bpz, Blr, Blz, Bbm, Bbx, and Bd for the other features may also be obtained.
(2) Classification of the degree of lameness.

A two-dimensional feature Bmov of the compensatory movement feature (also known as a total score of the compensatory movement feature) is calculated:

$$Bmov = Bvx + Bvz + Bpz + Blr + Blz \qquad ( 4 )$$

A two-dimensional feature Bpos of the compensatory posture feature (also known as a total score of the compensatory posture feature) is calculated:

$$Bpos = Bbm + Bbx + Bd \qquad ( 5 )$$

According to the above two feature values, a total lameness score of the cattle is calculated using the following formula:

$$score = \{ \begin{matrix}S , Bmov < 4 ⋂ Bpos < 2 \\ M L , Bmov \geq 4 ⋂ Bpos < 2 , Bmov < 4 ⋂ Bpos \geq 2 \\ S L , Bmov \geq 4 ⋂ Bpos \geq 2\end{matrix} \qquad ( 6 )$$

It should be noted that, in order to comprehensively consider the lameness in the cattle, the selected features are those that encompass all the features, specifically including the compensatory movement features and the compensatory posture features. The compensatory movement features include the average movement speed of the hook and the pin bone in the vertical direction, the average movement speed of the hook and the pin bone in the x direction, the landing speed of the hind hooves, the asymmetry of the pin bones, and the height difference of the sacral bone at the moment of landing of the hind hooves. The compensatory posture features include the maximum height of the contour of the spinal line, the fitting slope of the contour of the spinal line, and the height difference between the pin bone and the hook. Considering an actual situation, only one type of features from the compensatory movement features and the compensatory posture features may be selected for identification of lameness in the cattle. Furthermore, according to the actual situation, one, two, three or more than three features from the compensatory movement features may be selected, and one, two, three or more than three features from the compensatory posture features may be selected.

Based on the above, the disclosure has the following characteristics: 1) in the disclosure, the in-depth analysis of the stabilization mechanism of the back movement of the cattle is conducted, and the compensatory movement and compensatory posture features of the back lameness are extracted to implement top-view lameness detection; 2) based on the distribution characteristics of the hook in the cattle, the efficient method for locating the hook is provided; 3) based on the distribution characteristics of the pin bone in the cattle, the efficient method for locating the pin bone is provided; 4) the lameness classification method based on threshold discrimination is provided. This method first calculates the threshold according to the box plots of the features, and determines whether the cattle exhibit a certain compensatory lameness behavior according to this threshold. Then, the degree of lameness is determined according to the number and type of compensatory lameness behaviors exhibited by the cattle. This classification method does not require training and is more adaptable to the classification of small sample data.

The above provides specific implementation methods, but the disclosure is not limited to the described implementation methods. The basic idea of the disclosure lies in the above-mentioned basic scheme. For those skilled in the art, designing various modified models, formulas, and parameters based on the teachings of the disclosure does not require creative efforts. Any changes, modifications, substitutions, and variations made to the implementation methods without departing from the principles and spirit of the disclosure still fall within the scope of protection of the disclosure.

What is claimed is:

1. A method for identifying lameness in cattle based on features of back compensatory movement, comprising following steps:
1) obtaining a point cloud image of a back torso of the cattle during movement, and locating key parts of the cattle according to the point cloud image of the back torso;
2) extracting back compensatory features according to the key parts, wherein the back compensatory features comprise compensatory movement features and/or compensatory posture features, the compensatory movement features comprise at least one of an average movement speed of a hook and/or a pin bone in a vertical direction, an average movement speed of the hook and/or the pin bone in an x direction, a landing speed of hind hooves, asymmetry of the pin bones, and a height difference of a sacral bone at a moment of landing of the hind hooves, the compensatory posture features comprise at least one of a maximum height of a contour of a spinal line, a fitting slope of the contour of the spinal line, and a height difference between the pin bone and the hook, and the x direction is parallel to a direction of movement of the cattle;
3) identifying the lameness in the cattle according to the extracted back compensatory features.

2. The method for identifying the lameness in the cattle based on the features of the back compensatory movement according to claim 1, wherein the located key parts comprise the pin bone, and a z direction is defined as the vertical direction;
a method for calculating the landing speed of the hind hooves is: determine an x-z movement curve of the pin bone according to the located pin bone, and extract a local minimum point in the movement curve of an x-z direction; for one local minimum point, select one point before and one point after the local minimum point, both points are in a vicinity of the local minimum point, calculate an amount of change in values of the pin bone along the z direction in one frame from the selected point after the local minimum point moving to the local minimum point and an amount of change in values of the pin bone along the z direction in one frame from the local minimum point moving to the selected point before the local minimum point, calculate a mean of all the amounts of change in values of the pin bone along the z direction in one frame, and evaluate the landing speed of the hind hooves using the mean;
and/or
a method for calculating the asymmetry of the pin bones is: according to the located pin bone, determine movement curves of the left and right pin bones in the x-z direction, determine a number of points where the left and right pin bones have different trends of change in the z direction, and evaluate the asymmetry of the pin bones using the number.

3. The method for identifying the lameness in the cattle based on the features of the back compensatory movement according to claim 1, wherein the located key parts comprise the pin bone and the sacral bone;
a method for calculating the height difference of the sacral bone at the moment of landing of the hind hooves is: according to the located pin bone and the sacral bone, respectively determine a movement curve of the pin bone in an x-z direction and a movement curve of the sacral bone in the x-z direction, and extract a local minimum point in the movement curve of the pin bone in the x-z direction; obtain a position of the local minimum point in the movement curve of the sacral bone in the x-z direction at a corresponding moment, select one point before and one point after the position, both points are in a vicinity of the position, and calculate a distance between the two selected points in the z direction of the sacral bone, the distance is the height difference of the sacral bone at the moment of landing of the hind hooves, wherein the z direction is the vertical direction.

4. The method for identifying the lameness in the cattle based on the features of the back compensatory movement according to claim 1, wherein the located key parts comprise a spinal line and the hook; a y direction is defined to be along a horizontal direction and perpendicular to the x direction, and a z direction is the vertical direction;
a method for calculating a maximum height of the contour of the spinal line is: according to the located hook, determine a movement curve of the hook in an x-y direction, extract a first extreme point in the movement curve of the hook in the x-y direction, and determine the spinal line at a moment corresponding to the first extreme point; calculate a maximum value of the spinal line in the z direction, and the maximum value is the maximum height of the contour of the spinal line;
and/or
a method for calculating a fitting slope of the contour of the spinal line is: according to the located hook, determine the movement curve of the hook in the x-y direction, extract the first extreme point in the movement curve of the hook in the x-y direction, and determine the spinal line at the moment corresponding to the first extreme point; calculate the fitting slope of the spinal line, and the fitting slope is the fitting slope of the contour of the spinal line.

5. The method for identifying the lameness in the cattle based on the features of the back compensatory movement according to claim 1, wherein a method for locating the spinal line is:
2.1) use a sliding window with an equal side length and step size to traverse a frame of the point cloud image of the back torso and calculate a sum of depth values of each of windows; search the window with the largest sum of the depth values in each of columns, and determine a coordinate of a certain position of the window as one of initial coordinates for locating the spinal line, wherein the column is located in a y direction, and the y direction is along a horizontal direction and perpendicular to the x direction;
2.2) fit all the initial coordinates for locating the spinal line determined in the step 2.1) to obtain a fitting line, expand a first set region in both the positive and negative y directions with the fitting line as a starting position, and identify the expanded region as a potential region for the spinal line;
2.3) use the sliding window to traverse the potential region for the spinal line, and calculate the sum of the depth values of each of the windows; search the window with the largest sum of the depth values in each of the columns, and determine a coordinate of a certain position of the window as one of final coordinates for locating the spinal line; determine the spinal line in the frame of the point cloud image of the back torso according to all the final coordinates for locating the spinal line.

6. The method for identifying the lameness in the cattle based on the features of the back compensatory movement according to claim 4, wherein a method for locating the spinal line is:
2.1) use a sliding window with an equal side length and step size to traverse a frame of the point cloud image of the back torso and calculate a sum of depth values of each of windows; search the window with the largest sum of the depth values in each of columns, and determine a coordinate of a certain position of the window as one of initial coordinates for locating the spinal line, wherein the column is located in a y direction, and the y direction is along a horizontal direction and perpendicular to the x direction;
2.2) fit all the initial coordinates for locating the spinal line determined in the step 2.1) to obtain a fitting line, expand a first set region in both the positive and negative y directions with the fitting line as a starting position, and identify the expanded region as a potential region for the spinal line;
2.3) use the sliding window to traverse the potential region for the spinal line, and calculate the sum of the depth values of each of the windows; search the window with the largest sum of the depth values in each of the columns, and determine a coordinate of a certain position of the window as one of final coordinates for locating the spinal line; determine the spinal line in the frame of the point cloud image of the back torso according to all the final coordinates for locating the spinal line.

7. The method for identifying the lameness in the cattle based on the features of the back compensatory movement according to claim 1, wherein a method for locating the hook is:
3.1) locate the spinal line in a frame of the point cloud image of the back torso, and rotate the image using the spinal line, so that an angle of the spinal line is 0;
3.2) traverse the rotated image column by column along the x direction to find a maximum depth value of each of columns; for a column, compare a depth value of each of pixels in the column with the maximum depth value of the column, and delete pixels that have a difference from the maximum depth value greater than a set difference threshold; then search a largest connected component in the image to be used as a top torso region, wherein the column is located in a y direction, and the y direction is along a horizontal direction and perpendicular to the x direction;
3.3) traverse along the x direction, calculate a pixel sum of each of the columns in a binary image of the top torso region, find a column with a maximum pixel sum, and identify the column as a potential column for the hook;
3.4) define a rectangular region, wherein upper and lower boundaries of the region are upper and lower boundaries of a torso, and left and right boundaries of the region are the boundaries obtained by extending a second set region in both the positive and negative x directions with the potential column for the hook as a starting position, and the rectangular region is a potential region for the hook;
3.5) use a sliding window with an equal side length and step size to traverse a y-z scatter plot in the potential region for the hook, replace all points in each of windows with a single point, and replace with a mean of y and z coordinates of all the points in the window, thereby using all the replaced points to obtain a fitting curve;
3.6) extract a convex hull of the fitting curve, calculate an area between a straight line where any two adjacent points are located on the convex hull and corresponding points on the fitting curve, find two points with the largest area that are located on the fitting curve and near two local maximum points of the fitting curve respectively, wherein the two points are the located left and right hook points.

8. The method for identifying the lameness in the cattle based on the features of the back compensatory movement according to claim 4, wherein a method for locating the hook is:
3.1) locate the spinal line in a frame of the point cloud image of the back torso, and rotate the image using the spinal line, so that an angle of the spinal line is 0;
3.2) traverse the rotated image column by column along the x direction to find a maximum depth value of each of columns; for a column, compare a depth value of each of pixels in the column with the maximum depth value of the column, and delete pixels that have a difference from the maximum depth value greater than a set difference threshold; then search a largest connected component in the image to be used as a top torso region, wherein the column is located in a y direction, and the y direction is along a horizontal direction and perpendicular to the x direction;
3.3) traverse along the x direction, calculate a pixel sum of each of the columns in a binary image of the top torso region, find a column with a maximum pixel sum, and identify the column as a potential column for the hook;
3.4) define a rectangular region, wherein upper and lower boundaries of the region are upper and lower boundaries of a torso, and left and right boundaries of the region are the boundaries obtained by extending a second set region in both the positive and negative x directions with the potential column for the hook as a starting position, and the rectangular region is a potential region for the hook;
3.5) use a sliding window with an equal side length and step size to traverse a y-z scatter plot in the potential region for the hook, replace all points in each of windows with a single point, and replace with a mean of y and z coordinates of all the points in the window, thereby using all the replaced points to obtain a fitting curve;
3.6) extract a convex hull of the fitting curve, calculate an area between a straight line where any two adjacent points are located on the convex hull and corresponding points on the fitting curve, find two points with the largest area that are located on the fitting curve and near two local maximum points of the fitting curve respectively, wherein the two points are the located left and right hook points.

9. The method for identifying the lameness in the cattle based on the features of the back compensatory movement according to claim 1, wherein a method for locating the pin bone is:
4.1) locate an oxtail bone region in the point cloud image of the back torso;
4.2) in an xoy plane, with a column where the oxtail bone region is located as a column where left and right pin bone regions are located, a row between an uppermost side of a torso and a largest row of the oxtail bone region is used as a row where the right pin bone region is located, a row between a smallest row of the oxtail bone region and a lowermost side of the torso is used as a row where the left pin bone region is located, wherein the column is located in a y direction, and the y direction is along a horizontal direction and perpendicular to the x direction;
4.3) retain the columns with larger x values in the left pin bone region, and use an average value of points of the retained columns as a coordinate value of a coarse location point of left pin bone; retain the columns with larger x values in the right pin bone region, and use an average value of points of the retained columns as a coordinate value of a coarse location point of right pin bone;
4.4) define two rectangular regions in the xoy plane, wherein upper and lower boundaries of one of the rectangular regions are lines after a connecting line of the left hook point and the coarse location point of left pin bone is translated upward and downward by set pixel points respectively, left and right boundaries of the rectangular region are perpendicular to the connecting line of the left hook point and the coarse location point of left pin bone, and one of the left and right boundaries has points after the coarse location point of left pin bone is translated towards a direction of a tail of the cattle by several pixel points, and the other of the left and right boundaries has points after the coarse location point of left hook is translated towards a direction of a head of the cattle by several pixel points; upper and lower boundaries of the other of the rectangular regions are lines after a connecting line of the right hook point and the coarse location point of right pin bone is translated upward and downward by set pixel points respectively, left and right boundaries of the rectangular region are perpendicular to the connecting line of the right hook point and the coarse location point of right pin bone, and one of the boundaries has points after the coarse location point of right pin bone is translated towards the direction of the tail of the cattle by several pixels, and the other of the boundaries has points after the coarse location point of right hook is translated towards the direction of the head of the cattle by several pixels;
4.5) processing the two obtained rectangular regions as follows: traversing an x-z scatter plot of the rectangular regions using a sliding window with an equal side length and step size, replacing all points in each of windows with a single point, and replacing with a mean of x and z coordinates of all the points in the window, thereby using all the replaced points to obtain a fitting curve; extract a convex hull of the fitting curve, calculating an area between a straight line where any two adjacent points are located on the convex hull and the fitting curve, finding points with the largest area on the fitting curve, and using a point closest to a tail of the cattle as one of the pin bone points, wherein a z direction is a vertical direction.

10. The method for identifying the lameness in the cattle based on the features of the back compensatory movement according to claim 2, wherein a method for locating the pin bone is:
4.1) locate an oxtail bone region in the point cloud image of the back torso;
4.2) in an xoy plane, with a column where the oxtail bone region is located as a column where left and right pin bone regions are located, a row between an uppermost side of a torso and a largest row of the oxtail bone region is used as a row where the right pin bone region is located, a row between a smallest row of the oxtail bone region and a lowermost side of the torso is used as a row where the left pin bone region is located, wherein the column is located in a y direction, and the y direction is along a horizontal direction and perpendicular to the x direction;
4.3) retain the columns with larger x values in the left pin bone region, and use an average value of points of the retained columns as a coordinate value of a coarse location point of left pin bone; retain the columns with larger x values in the right pin bone region, and use an average value of points of the retained columns as a coordinate value of a coarse location point of right pin bone;
4.4) define two rectangular regions in the xoy plane, wherein upper and lower boundaries of one of the rectangular regions are lines after a connecting line of the left hook point and the coarse location point of left pin bone is translated upward and downward by set pixel points respectively, left and right boundaries of the rectangular region are perpendicular to the connecting line of the left hook point and the coarse location point of left pin bone, and one of the left and right boundaries has points after the coarse location point of left pin bone is translated towards a direction of a tail of the cattle by several pixel points, and the other of the left and right boundaries has points after the coarse location point of left hook is translated towards a direction of a head of the cattle by several pixel points; upper and lower boundaries of the other of the rectangular regions are lines after a connecting line of the right hook point and the coarse location point of right pin bone is translated upward and downward by set pixel points respectively, left and right boundaries of the rectangular region are perpendicular to the connecting line of the right hook point and the coarse location point of right pin bone, and one of the boundaries has points after the coarse location point of right pin bone is translated towards the direction of the tail of the cattle by several pixels, and the other of the boundaries has points after the coarse location point of right hook is translated towards the direction of the head of the cattle by several pixels;
4.5) processing the two obtained rectangular regions as follows: traversing an x-z scatter plot of the rectangular regions using a sliding window with an equal side length and step size, replacing all points in each of windows with a single point, and replacing with a mean of x and z coordinates of all the points in the window, thereby using all the replaced points to obtain a fitting curve; extract a convex hull of the fitting curve, calculating an area between a straight line where any two adjacent points are located on the convex hull and the fitting curve, finding points with the largest area on the fitting curve, and using a point closest to a tail of the cattle as one of the pin bone points, wherein a z direction is a vertical direction.

11. The method for identifying the lameness in the cattle based on the features of the back compensatory movement according to claim 3, wherein a method for locating the pin bone is:
4.1) locate an oxtail bone region in the point cloud image of the back torso;
4.2) in an xoy plane, with a column where the oxtail bone region is located as a column where left and right pin bone regions are located, a row between an uppermost side of a torso and a largest row of the oxtail bone region is used as a row where the right pin bone region is located, a row between a smallest row of the oxtail bone region and a lowermost side of the torso is used as a row where the left pin bone region is located, wherein the column is located in a y direction, and the y direction is along a horizontal direction and perpendicular to the x direction;
4.3) retain the columns with larger x values in the left pin bone region, and use an average value of points of the retained columns as a coordinate value of a coarse location point of left pin bone; retain the columns with larger x values in the right pin bone region, and use an average value of points of the retained columns as a coordinate value of a coarse location point of right pin bone;
4.4) define two rectangular regions in the xoy plane, wherein upper and lower boundaries of one of the rectangular regions are lines after a connecting line of the left hook point and the coarse location point of left pin bone is translated upward and downward by set pixel points respectively, left and right boundaries of the rectangular region are perpendicular to the connecting line of the left hook point and the coarse location point of left pin bone, and one of the left and right boundaries has points after the coarse location point of left pin bone is translated towards a direction of a tail of the cattle by several pixel points, and the other of the left and right boundaries has points after the coarse location point of left hook is translated towards a direction of a head of the cattle by several pixel points; upper and lower boundaries of the other of the rectangular regions are lines after a connecting line of the right hook point and the coarse location point of right pin bone is translated upward and downward by set pixel points respectively, left and right boundaries of the rectangular region are perpendicular to the connecting line of the right hook point and the coarse location point of right pin bone, and one of the boundaries has points after the coarse location point of right pin bone is translated towards the direction of the tail of the cattle by several pixels, and the other of the boundaries has points after the coarse location point of right hook is translated towards the direction of the head of the cattle by several pixels;
4.5) processing the two obtained rectangular regions as follows: traversing an x-z scatter plot of the rectangular regions using a sliding window with an equal side length and step size, replacing all points in each of windows with a single point, and replacing with a mean of x and z coordinates of all the points in the window, thereby using all the replaced points to obtain a fitting curve; extract a convex hull of the fitting curve, calculating an area between a straight line where any two adjacent points are located on the convex hull and the fitting curve, finding points with the largest area on the fitting curve, and using a point closest to a tail of the cattle as one of the pin bone points, wherein a z direction is a vertical direction.

12. The method for identifying the lameness in the cattle based on the features of the back compensatory movement according to claim 1, wherein a method for locating the sacral bone is: locate the spinal line and the left and right hooks in a frame of the point cloud image of the back torso, wherein if a column where the left and right hooks are located intersects with the spinal line, then the intersection point is a position of the sacral bone; if the column where the left and right hooks are located does not intersect with the spinal line, then a point that is closer to both the column where the left and right hooks are located and the spinal line is considered to be the position of the sacral bone, wherein the column is located in a y direction, and the y direction is along a horizontal direction and perpendicular to the x direction.

13. The method for identifying the lameness in the cattle based on the features of the back compensatory movement according to claim 3, wherein a method for locating the sacral bone is: locate the spinal line and the left and right hooks in a frame of the point cloud image of the back torso, wherein if a column where the left and right hooks are located intersects with the spinal line, then the intersection point is a position of the sacral bone; if the column where the left and right hooks are located does not intersect with the spinal line, then a point that is closer to both the column where the left and right hooks are located and the spinal line is considered to be the position of the sacral bone, wherein the column is located in a y direction, and the y direction is along a horizontal direction and perpendicular to the x direction.

14. The method for identifying the lameness in the cattle based on the features of the back compensatory movement according to claim 1, wherein the method for identifying the lameness in the cattle based on the extracted back compensatory features is:
compare each of the back compensatory features with a corresponding back compensatory feature threshold, and determine a corresponding feature score according a magnitude relationship between each of the back compensatory features and the corresponding back compensatory feature threshold; obtain a total score of the compensatory movement features by adding feature scores corresponding to each of compensatory movement features, and obtain a total score of the compensatory posture features by adding feature scores corresponding to each of the compensatory posture features; evaluate a degree of lameness in the cattle according to the total score of compensatory movement features and the total score of compensatory posture features.

15. The method for identifying the lameness in the cattle based on the features of the back compensatory movement according to claim 14, wherein a method for determining the back compensatory feature threshold corresponding to the compensatory movement features is: obtain box plots of compensatory movement features of healthy and mildly lame cattle, calculate an average value of a lower quartile of the box plot of the healthy cattle and an upper quartile of the box plot of the mildly lame cattle, and use the average value as the back compensatory feature threshold corresponding to the compensatory movement features;
and/or
a method for determining the back compensatory feature threshold corresponding to the compensatory posture features is: obtain box plots of compensatory posture features of mildly lame and severely lame cattle, calculate an average value of a lower quartile of the mildly lame cattle and an upper quartile of the severely lame cattle, and use the average value as the back compensatory feature threshold corresponding to the compensatory posture features.
